(19) United States
(12) Patent Application Publication
(10) Pub. No.: US 2014/0082832 A1
(43) Pub. Date: Mar. 27, 2014

(54) ERGONOMETRIC BEDPAN WITH REMOVABLE BAG

(71) Applicant: Michelle Marshall, Hollywood, FL (US)

(72) Inventor: Michelle Marshall, Hollywood, FL (US)

(21) Appl. No.: 13/624,135

(22) Filed: Sep. 21, 2012

(51) Int. Cl. A61G 9/00

(52) U.S. Cl. 4/452

(57) ABSTRACT

A bedpan with a wedge-shaped housing assembly that includes an opening with a cushion assembly mounted thereon for redistribution a user's weight. A liner bag assembly with a closing string is removably mounted within the housing assembly to collect a user's waste. The liner bag assembly is readily retrievable after being closed while inside the housing assembly. An adhesive is applied to the internally mount the bag assembly to the housing or the inner surface of the cushion assembly.

### BACKGROUND OF THE INVENTION

1. Field of the Invention

The present invention relates to bedpans and, more particularly, to those bedpans that include an ergonomic cuneiform shape with a removable liner bag assembly for easy removal of contained waste with minimal manipulation.

2. Description of the Related Art

Several bedpans have been used or designed in the past. None of them, however, include an ergonomic cuneiform bedpan with a cushion assembly that cooperates to cover a user's peritoneal area resulting in a substantially liquid tight engagement re-distributing the user's weight to prevent and ameliorate injury to bedridden patients. The need for a stable bedpan with the means to contain the waste to be retrieved is quite desirable.

Applicant believes that one of the related reference corresponds to U.S. Pat. No. 3,939,502 issued to Majorie A Miller in 1976 for a disposable pad for bedpans. Miller's patent discloses a pad member 11 that includes padding 14. While padding 14 provides some comfort to the user, it nonetheless compresses when transmitting the user's weight as any other solid object would. The use of a cushion, specially a gel in a pillow or enclosure, has the advantage of conforming to a user's body permitting the easy re-distributing of the user's weight. Other features such as the ergonomic wedge-shape and removable liner bag assembly are not disclosed either.

U.S. patent publication No. US2010/0107326 listing David P. Joseph as the inventor discloses a universal fit bedpan pad 40. The shape of the bedpan and pad 40 may approach the shape of a wedge. But, the buttock support region 26 still has large dimensions that prevent the insertion of the bedpan to utilize the effect of the wedge shape under a user's body. The extended pointed, yet curved, and in the present invention facilitates the insertion of the bedpan. Nor, are the ski members disclosed to minimize lateral movements.

Additionally, none of the references disclose or suggest the use removable bags or bays that work as handles, for the readily manipulation of the bedpan. These bays do not protrude like a handle would but they still provide the same function. A health provider, nurse or any other person helping the user, will be able to readily manipulate the bedpan with these bays. These bays are unique, new and non-obvious. The bays are cooperatively located (molded in) on the bedpan walls at pre-selected locations.

The present invention also includes a liner bag that is removably receivable within bedpan through an opening on the upper side of the housing. A string is provided for closing the only opening of the bag with a peripheral pressure sensitive adhesive for mounting the area adjacent to the bag's opening to the internal surface of the cushion assembly. While the bedpan is still in place, a user may pull the string to close the line bag assembly thus minimizing spillage.

These novel features are not shown in the prior art and provide competitive advantages not previously taught by the references known to the applicant.

Other documents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a bedpan that minimizes or prevents the imminent risk to develop pressure ulcers and other complications in bedridden users.

It is another object of this invention to provide a bedpan that can be readily manipulated.

It is still another object of the present invention to provide a bedpan with a removable bag so that the user's waste can be retrieved without spills.

Yet another object is to prevent the spread of microorganisms associated with fecal and urinary waste that can cause infections due to direct contact with the patient or care taker.

It is yet another object of this invention to provide such a bedpan that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an elevational side view of one of the embodiments of the present invention showing its ergonometric cuneiform shape without the liner bag assembly 60.

FIG. 2 shows a top view of the bedpan shown in the previous figure with cushion assembly 40 removed.

FIG. 3 illustrates a front elevational view of the bedpan shown in the previous figures.

FIG. 4 is a rear elevational view of the bedpan shown in the previous figures.

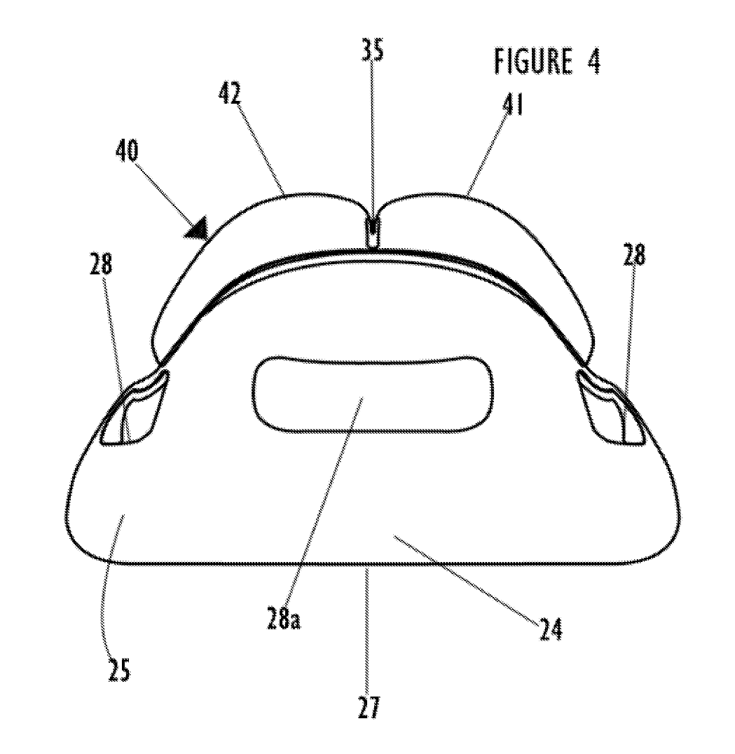

FIG. 5 is an isometric representation of the bedpan shown in the previous figures, seen at an angle from the front.

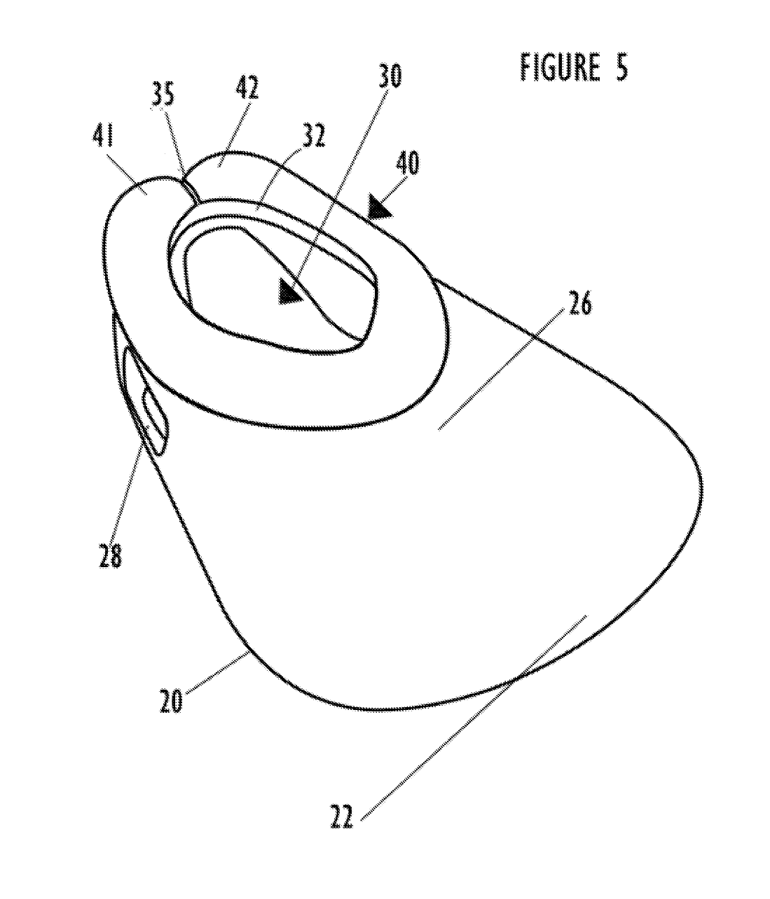

FIG. 6 is an isometric representation of the bedpan shown in the previous figures, seen at an angle from the rear.

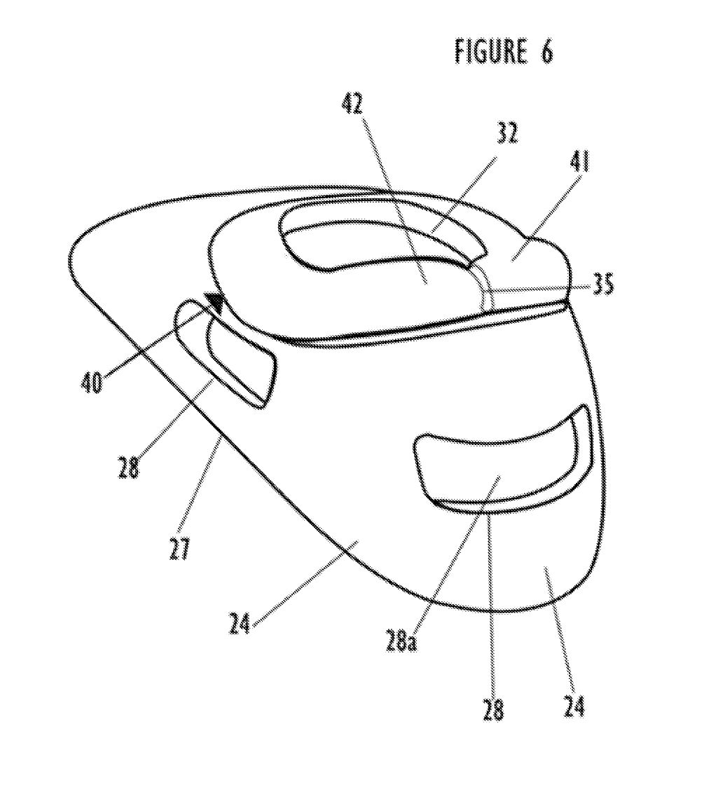

FIG. 7 is a bottom view of the bedpan shown in the previous figures.

FIG. 8 is a side elevational view, similar to FIG. 1, with the liner bag assembly mounted.

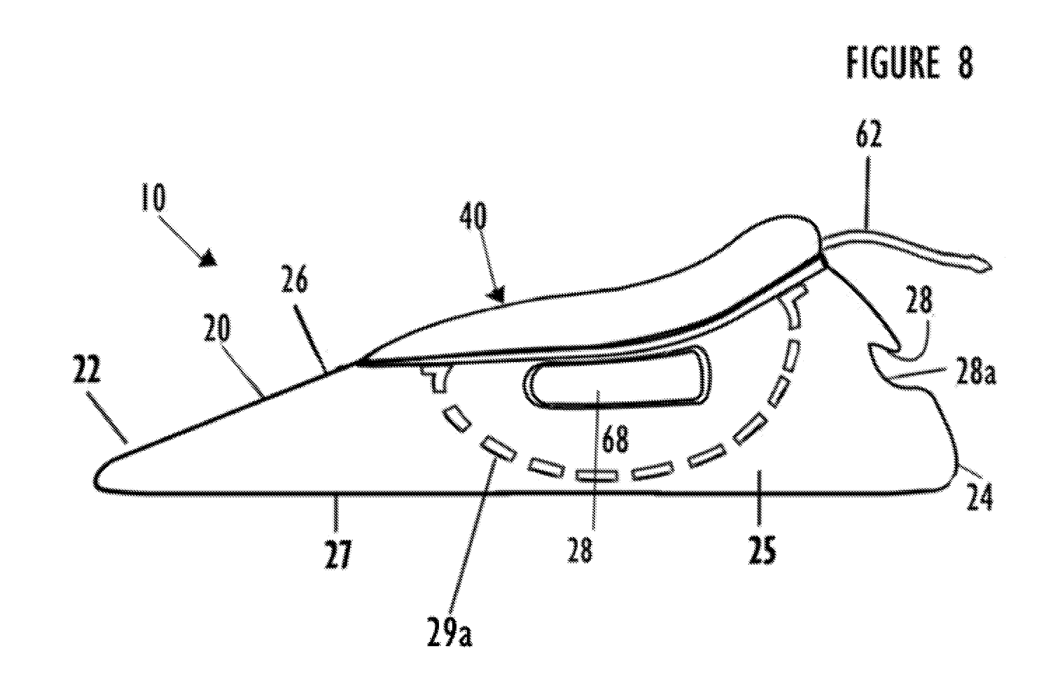

FIG. 9 is a side elevational cross-sectional view of the bedpan represented in the previous figures showing the internal disposition of the liner bag assembly 60 mounted therein.

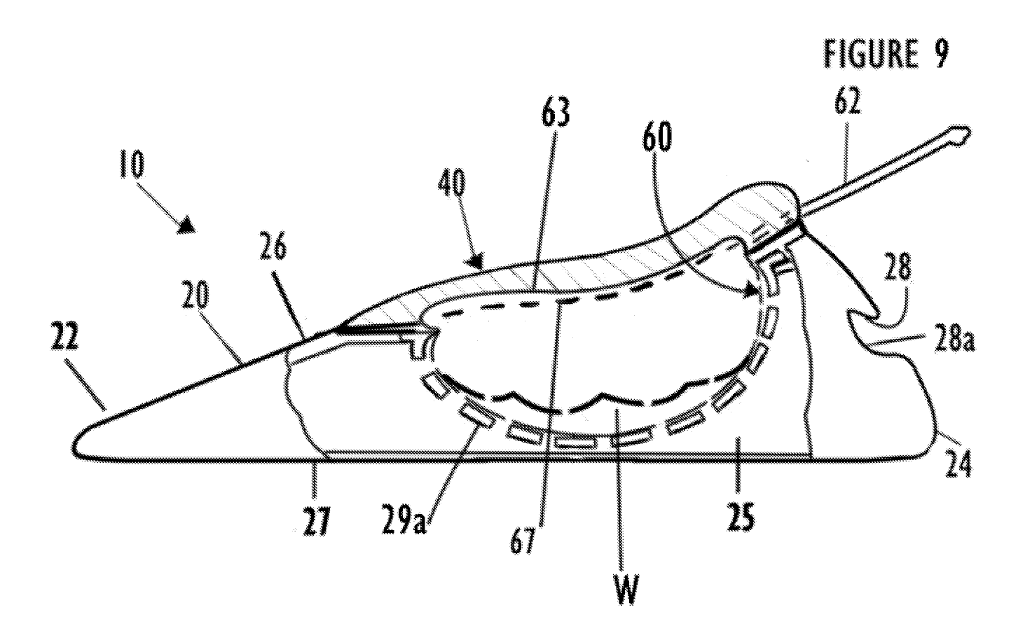

FIG. 10 is a side elevational view of the bedpan represented in the previous figures with the string being pulled and the distal end portion of the bag with the opening being detached (with less adhesive) and the end portion of the bag opening 63 closer to the rear still attached as the opening is being closed.

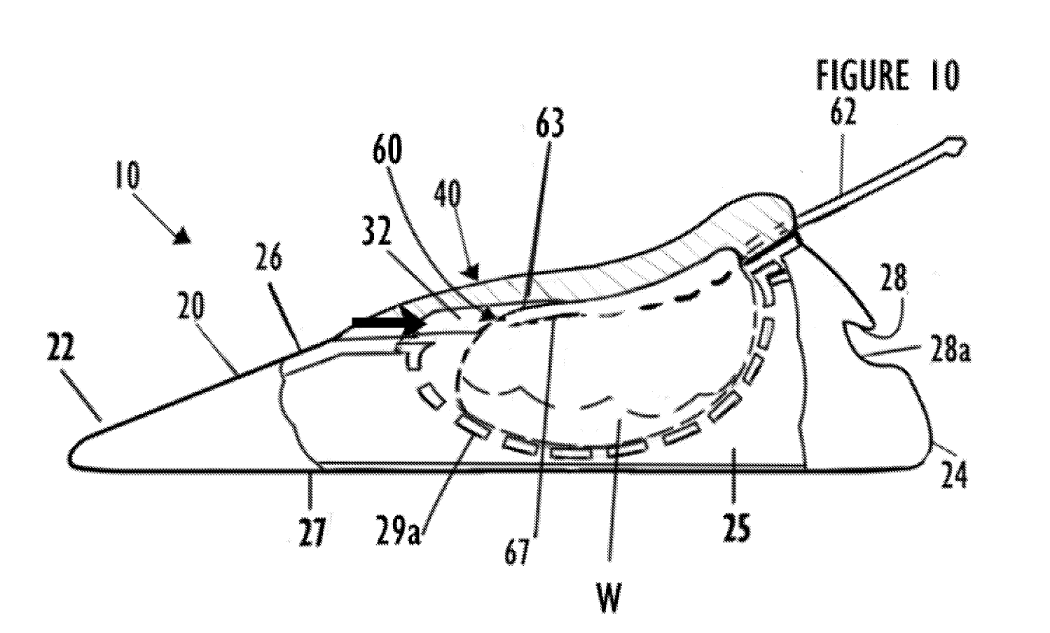

FIG. 11 is an isometric view of the bedpan represented in the previous figure with bag opening 63 being closed.

FIG. 12 is a side elevational view of the bedpan shown in the previous figures with the liner bag assembly being retrieved with the bag opening 63 closed containing waste W.

FIG. 13 is an isometric view of liner bag assembly 60 with more adhesive material 69 on the end portion closer to string and diminishing amount of adhesive material towards the distal end portion of the bag opening.

### DETAILED DESCRIPTION OF THE EMBODIMENTS OF THE INVENTION

Referring now to the drawings, where the present invention is generally referred to with numeral 10, it can be observed that it basically includes bedpan housing assembly 20, cushion assembly 40 and liner bag assembly 60, the latter being removably housed within housing assembly 20.

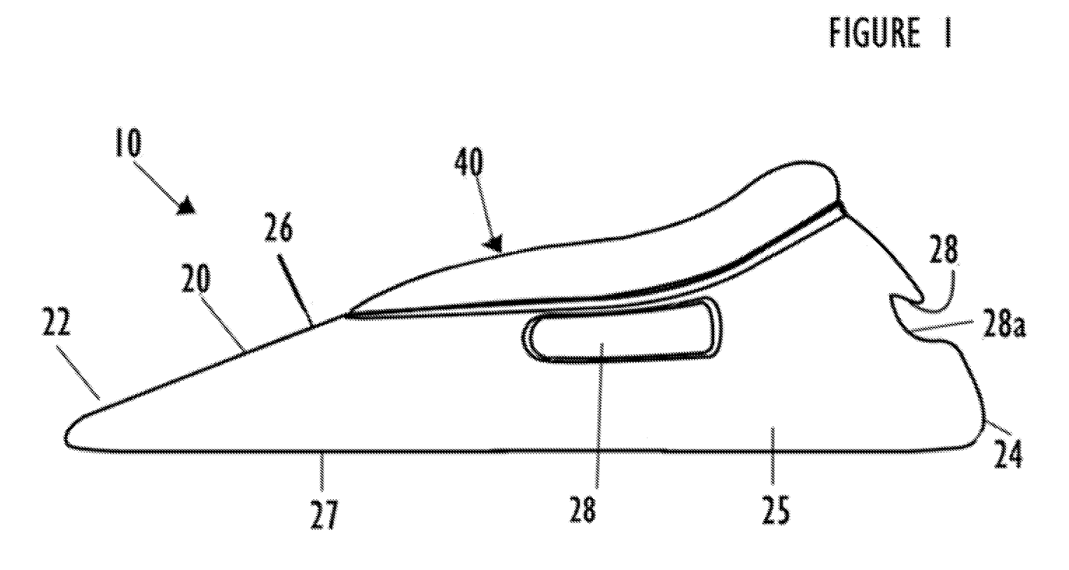

In one of the embodiments housing assembly 20 has a cuneiform shape like an elongated wedge with what is referred to as front end 22 having a rounded contour and considerably smaller height than rear end 24, as best seen in FIG. 1.

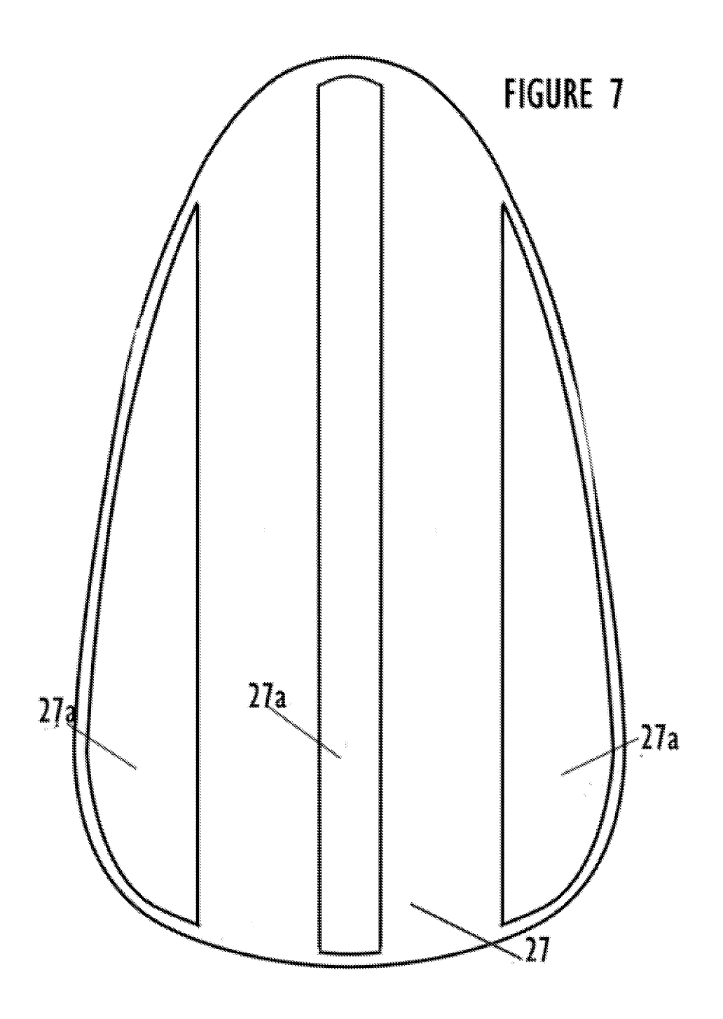

Housing assembly 20 has a peripheral side wall 25, upper wall 26, and bottom wall 27, as seen in FIGS. 1 and 7. Peripheral side wall 25 has a predetermined height at rear end 24 and decreases as it approaches front end 22, as best shown in FIGS. 1; 5 and 6. Bays 28 are molded at different locations around peripheral sidewall 25 providing a cooperative gripping structure to permit a person helping a user to readily manipulate bedpan 10. Bays 28 are concave and do not protrude outwardly thereby keeping a flush surface except where the inwardly concave portion exists. Bays 28 include inwardly extending walls 28a that permit a helper to lift, rotate or otherwise move bedpan 10 even under slippery conditions.

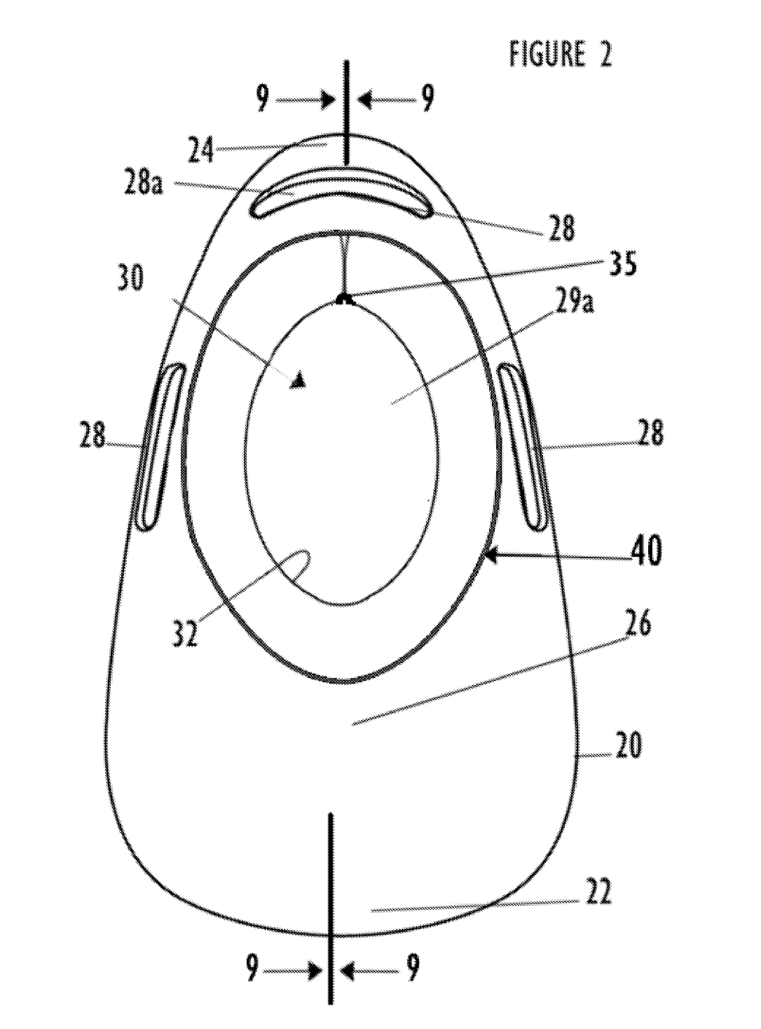

Housing assembly 20 also includes an opening 30 on upper wall 26 that in the represented embodiment has an oval shape, as best seen in FIG. 2. Peripheral rim 32 extends adjacent to, and inwardly from, opening 30. Cavity 29 extends from rim 32 and is defined by a continuous concave wall 29a that contains any waste that may spill. This concave wall 29a can be a removable piece that is mounted to wall 26 adjacent to opening 30. Bottom wall 27 is substantially flat providing a large area for distributing the weight of a user bearing on bedpan 10 resulting in a stable structure, as seen in FIG. 7. In one of the embodiments, ski members 27a are provided to facilitate the insertion of bedpan 10 and minimize lateral movements once deployed.

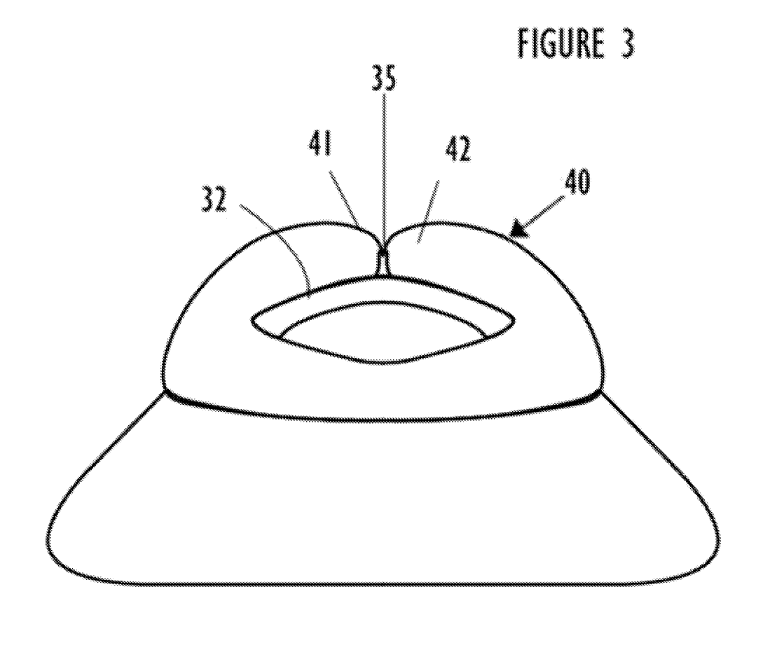

Cushion assembly 40 is optionally implemented with a gel pillow or enclosure and is mounted on upper wall 26, adjacent to opening 30, indicated as peripheral area 26a. Cushion assembly is removably mounted to area 26a and extends around the periphery of opening 30, except at one location that is referred to as cut out 35, as best seen in FIGS. 3; 4 and 5. Cut out 35 is preferably located towards rear end 24 and it is narrow enough to bite string 62 to keep it in place. Cut out 35 is formed by the abutting ends 41; 42 of cushion assembly 40.

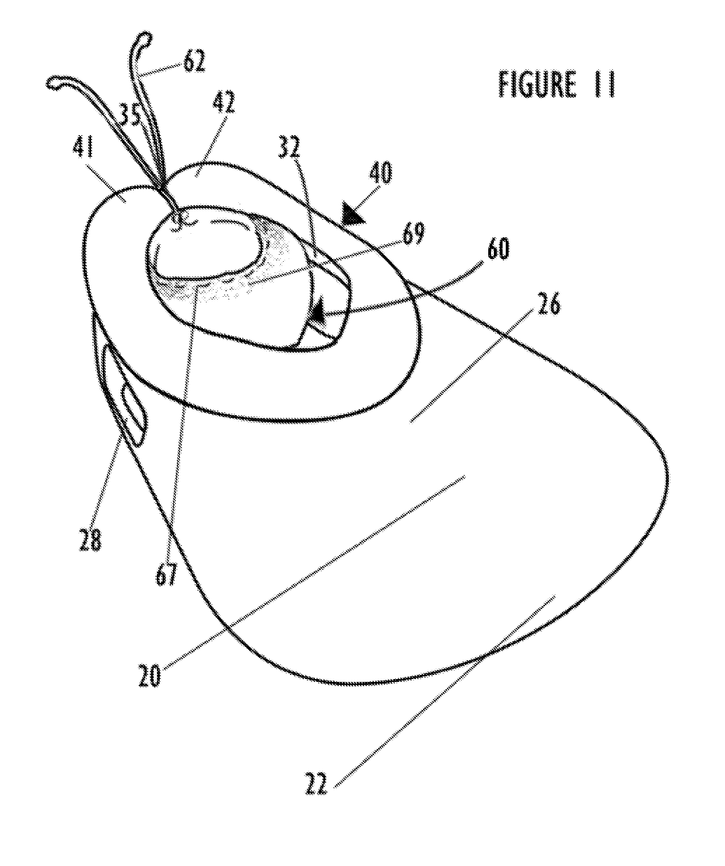

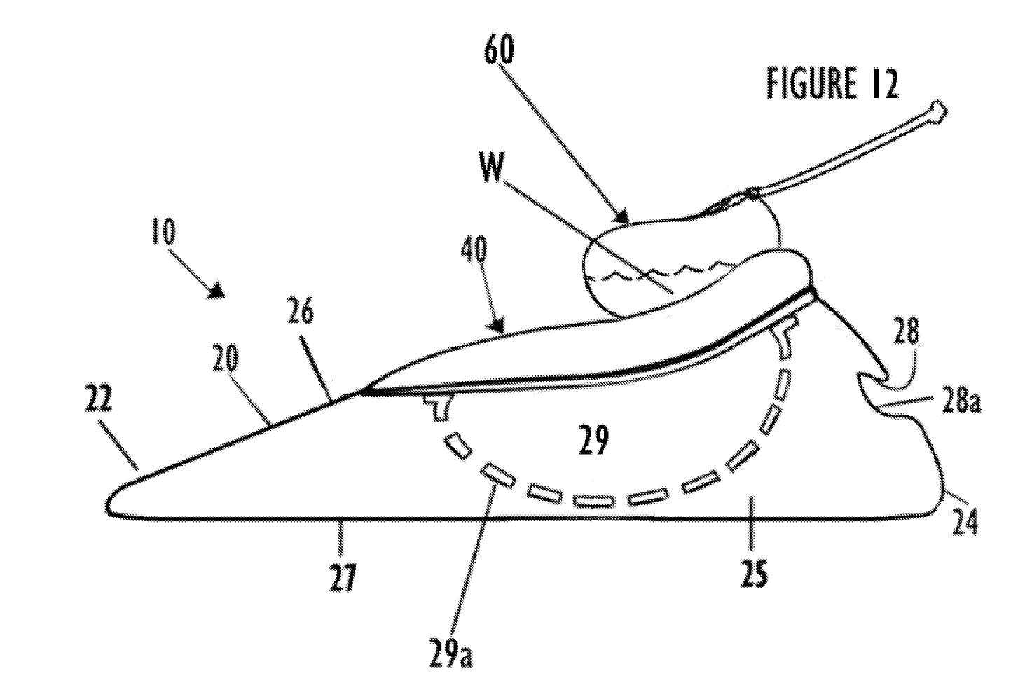

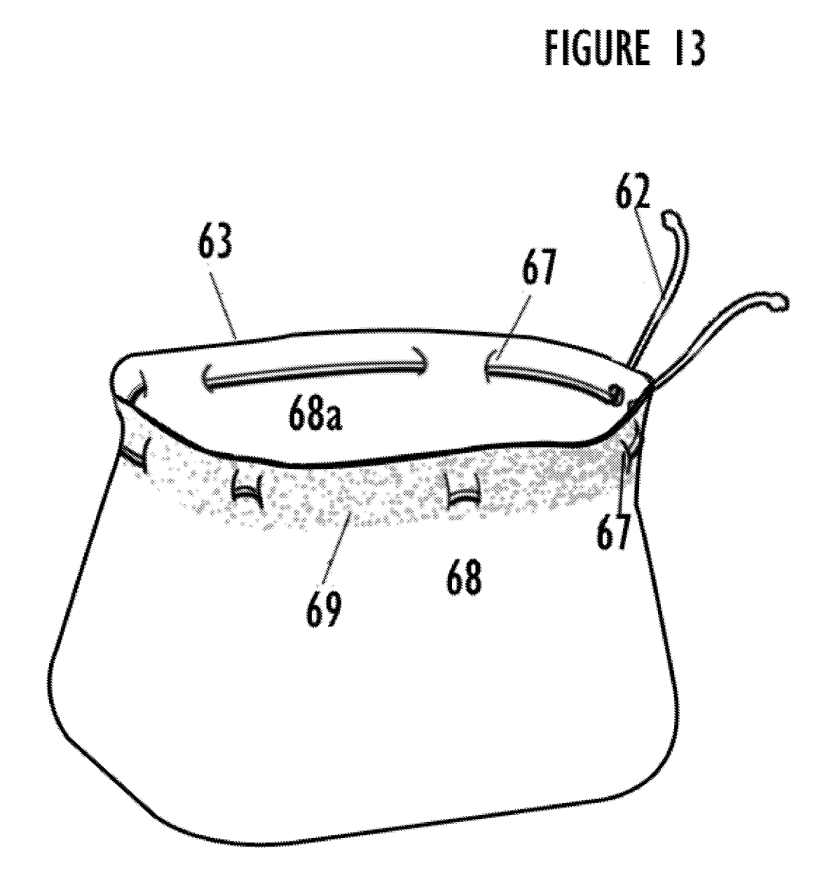

Liner bag assembly 60 is removably mounted to peripheral rim 32 or internal wall 41 of cushion assembly 40, or both. Adhesive material 69 is applied to the outer surface of liner bag assembly 60 along an area of the end portion adjacent to bag opening 63, as best seen in FIG. 13. Adhesive material 69 can be of different types and having different strengths depending on the location where it is applied. As represented in FIG. 13, stronger (or more) adhesive material is applied to the area of the end portion that is closer to the loose end of string 62 that is pulled to constrain bag opening 63. As it can be seen in FIGS. 11 and 12, as string 62 is pulled, the area of the bag liner's outer surface 68 with less adhesive detaches first. As bag opening 63 decreases in size the portion with more adhesive starts detaching. This minimizes the risk of waste spillage. When opening 63 is completely closed, then additional pulling force from string 62 detaches the last remaining portion that is still attached. And these actions can be accomplished while bedpan 10 is still deployed under the bedridden person.

String 62 is passed through openings 67. Preferably, the spacing of openings 67 is arranged in pairs with separations between the pairs that is larger than the separation between the openings 67 constituting the pair. This permits string 62 to pass therethrough with less exposure on the outer surface 68 and more exposure on inner surface 68a. This is intended to avoid or minimize the interference of string 62 with the action of adhesive 69.

To use bedpan 10, a user (assisting the patient) first lines up bedpan housing assembly 20 with the patient's body, bringing front end 22 in contact with his or her buttocks. Then, front end 22 is pushed cammingly raising the patient's buttocks, with some help from the user, until the patient's peritoneal area is positioned within opening 30. At this point, cushion assembly 40 is conformed to the patient's body to achieve as much of a liquid tight interface as possible. Before retrieving bedpan 10, the user can start pulling string 62 to constrain bag opening 63, subsequently bag assembly 60 is removed for disposal. In this manner, waste W is contained and risk of spillage is minimized.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A bedpan, comprising:
A) a housing assembly having an elongated wedge shape with first and second ends, said second end having a taller elevational dimension than said first end, and said housing assembly further including a bottom wall, a peripheral side wall and an upper wall, said upper wall including an opening thereon with an adjacent inwardly extending rim and a removable concave wall mounted to said upper wall adjacent to said opening having a cavity defined therein internal of said housing, and said peripheral wall includes at least one inwardly extending bay formed thereon for the manipulation of said bedpan;
B) a cushion assembly mounted to said upper wall, adjacent to said opening, said cushion assembly defining an inner surface and having cooperative dimensions to form a substantially liquid tight engagement with a users' body surrounding peritoneal area; and
C) a liner bag assembly removably housed within said cavity and further including a bag member with a bag opening having a portion adjacent to said bag opening that is removably mounted to said cushion inner surface for the collection and removal of a user's waste.

2. The bedpan set forth in claim 1 wherein said cushion assembly includes a deformable gel enclosure.

3. The bedpan set forth in claim 2 wherein said liner bag assembly includes a string with two ends and a plurality of openings adjacent to said bag opening through which said string is passed leaving the two ends loose to cooperatively constrain said opening when said string ends are pulled.

4. The bedpan set forth in said claim 3 wherein said portion includes an adhesive material to removably mount said bag portion to said inner surface.

5. The bedpan set forth in claim 4 wherein the strength of said adhesive material is stronger in the area of said portion that is closer to said string ends, so that when said string is pulled the area of said portion that is further away from the ends of said string is detached first.

6. The bedpan set forth in claim 1 wherein said bottom wall includes at least one longitudinally extending ski member to facilitate the insertion of the bedpan under a user resting on a horizontal surface.

7. A bedpan, comprising:
A) a housing assembly having an elongated wedge shape with first and second ends, said second end having a taller elevational dimension than said first end, and said housing assembly further including a bottom wall, a peripheral side wall and an upper wall, said upper wall including an opening thereon with an adjacent inwardly extending rim and a cavity defined therein internal of said housing, and said peripheral wall includes at least one inwardly extending bay formed thereon for the manipulation of said bedpan;
B) a cushion assembly mounted to said upper wall, adjacent to said opening, said cushion assembly defining an inner surface and having cooperative dimensions to form a substantially liquid tight engagement with a users' body surrounding peritoneal area; and
C) a liner bag assembly removably housed within said cavity and further including a bag member, with a bag opening, having a portion adjacent to said bag opening that is removably mounted to said rim for the collection and removal of a user's waste.

8. The bedpan set forth in claim 7 wherein said cushion assembly includes a deformable gel enclosure.

9. The bedpan set forth in claim 8 wherein said liner bag assembly includes a string with two ends and a plurality of openings adjacent to said bag opening through which said string is passed leaving the two ends loose to cooperatively constrain said opening when said string ends are pulled.

10. The bedpan set forth in said claim 9 wherein said portion includes an adhesive material to removably mount said bag portion to said rim.

11. The bedpan set forth in claim 10 wherein the strength of said adhesive material is stronger in the area of said portion that is closer to said string ends, so that when said string is pulled the area of said portion that is further away from the ends of said string is detached first.

12. The bedpan set forth in claim 11 wherein said bottom wall includes at least one longitudinally extending ski member to facilitate the insertion of the bedpan under a user resting on a horizontal surface.
